(19) United States
(12) Patent Application Publication
(10) Pub. No.: US 2025/0078707 A1
(43) Pub. Date: Mar. 6, 2025

(54) IMAGE PRESENTING METHOD AND DISPLAY APPARATUS

(71) Applicant: Acer Incorporated, New Taipei City (TW)

(72) Inventors: Chi-Kang Lee, New Taipei City (TW); Chao-Kuang Yang, New Taipei City (TW); Shih-Hao Lin, New Taipei City (TW); Wen-Cheng Hsu, New Taipei City (TW)

(73) Assignee: Acer Incorporated, New Taipei City (TW)

(21) Appl. No.: 18/488,977

(22) Filed: Oct. 17, 2023

(30) Foreign Application Priority Data
Sep. 6, 2023 (TW) 112133837

(51) Int. Cl. G09G 3/00; G06F 1/16; G06F 3/04845; G06F 3/0485

(52) U.S. Cl. CPC G09G 3/035; G06F 1/1652; G06F 3/04845; G06F 3/0485; G09G 2340/0407; G09G 2340/0464; G09G 2354/00

(57) ABSTRACT

An image presenting method and a display apparatus are provided. The method includes: presenting at least one virtual screen and a tool bar image in a display interface of a rollable display; detecting a physical status of the rollable display; and adjusting presenting positions of the tool bar image and the at least one virtual screen in the display interface in response to a change in the physical status.

### CROSS-REFERENCE TO RELATED APPLICATION

This application claims the priority benefit of Taiwan application serial no. 112133837, filed on Sep. 6, 2023. The entirety of the above-mentioned patent application is hereby incorporated by reference herein and made a part of this specification.

### BACKGROUND

### Technical Field

The disclosure relates to an image display technology, and in particular, relates to an image presenting method and a display apparatus.

### Description of Related Art

With the advancement of technology, display apparatuses with rollable displays (such as smartphones or notebook computers) have hit the market. However, under the commonly-available Microsoft Windows operating system (OS) or Apple's iOS architecture, the layout and presentation of desktop images displayed on any type of monitor are fixed and cannot be customized for the rollable nature of the monitor. Therefore, in some cases, a user may enjoy a convenient operating experience when using the rollable display.

### SUMMARY

The disclosure provides an image presenting method and a display apparatus capable of improving a user's operating experience for a rollable display.

An embodiment of the disclosure provides an image presenting method for a display apparatus. The display apparatus includes a rollable display. The image presenting method includes the following steps. At least one virtual screen and a tool bar image are presented in a display interface of the rollable display. A physical status of the rollable display is detected. In response to a change in the physical status, presenting positions of the tool bar image and the at least one virtual screen in the display interface are adjusted.

An embodiment of the disclosure further provides a display apparatus including a rollable display and a processor. The processor is coupled to the rollable display. The processor is configured to present at least one virtual screen and a tool bar image in a display interface of the rollable display, detect a physical status of the rollable display, and adjust presenting positions of the tool bar image and the at least one virtual screen in the display interface in response to a change in the physical status.

To sum up, the at least one virtual screen and the tool bar image can be presented in the display interface of the rollable display. After a change in the physical status of the rollable display is detected, the presenting positions of the tool bar image and the at least one virtual screen in the display interface are adjusted. In this way, compared to the fixed conventional layout and presenting method of the desktop image presented by the monitor, the image presenting method and display apparatus provided by the disclosure is capable of effectively improving the user's operating experience for a rollable display.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a block diagram illustrating functions of a display apparatus according to an embodiment of the disclosure.

FIG. 2 is a schematic view illustrating a change in a physical status of a rollable display according to an embodiment of the disclosure.

FIG. 3A is schematic view illustrating adjustment of presenting positions of a tool bar image and a virtual screen in a display interface of the rollable display according to an embodiment of the disclosure.

FIG. 3B is schematic view illustrating presentation of a plurality of tool bar images and a plurality of virtual screens in the display interface of the rollable display according to an embodiment of the disclosure.

FIG. 3C is schematic view illustrating adjustment of the presenting positions of the tool bar image and the virtual screen in the display interface of the rollable display according to an embodiment of the disclosure.

FIG. 3D is schematic view illustrating adjustment of the presenting positions of the tool bar image and the virtual screen in the display interface of the rollable display according to an embodiment of the disclosure.

FIG. 4 is a flow chart of an image presenting method according to an embodiment of the disclosure.

### DESCRIPTION OF THE EMBODIMENTS

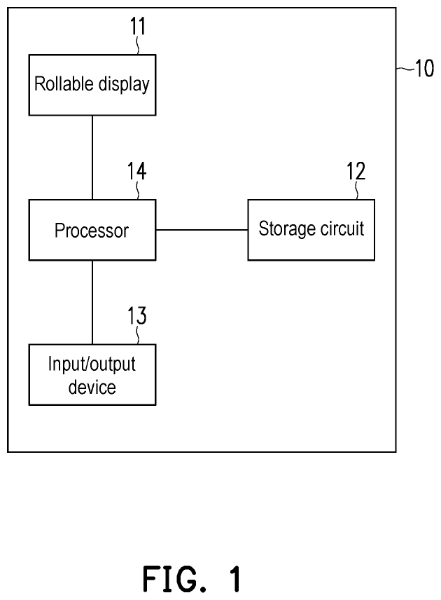

FIG. 1 is a block diagram illustrating functions of a display apparatus according to an embodiment of the disclosure. With reference to FIG. 1, a display apparatus 10 may include a smartphone, a tablet computer, a notebook computer, an e-reader, a game console, or any other electronic apparatus with a display function.

The display apparatus 10 may include a rollable display 11, a storage circuit 12, an input/output (IO) device 13, and a processor 14. The rollable display 11 is configured to display an image and is a flexible display. For instance, the rollable display 11 may include a flexible display such as an electronic paper (E-ink) or an organic light emitting diode (OLED) display. It should be noted that the display type of the rollable display 11 is not limited thereto.

The storage circuit 12 is configured to store data. For instance, the storage circuit 12 may include a volatile storage circuit and a non-volatile storage circuit. The volatile storage circuit is configured for volatile storage of data. For instance, the volatile storage circuit may include a random access memory (RAM) or similar volatile storage media. The non-volatile storage circuit is used for non-volatile storage of data. For instance, the non-volatile storage circuit may include a read only memory (ROM), a solid state disk (SSD), a conventional hard disk drive (HDD), or similar non-volatile storage media. It should be noted that the type of storage circuit 12 is not limited thereto.

The input/output device 13 is configured to receive an input signal or send an output signal. For instance, the input/output device 13 may include a physical keyboard, a touch panel, a mouse, a network interface card, and/or a speaker. It should be noted that the type of input/output device 13 is not limited thereto.

The processor 14 is coupled to the rollable display 11, the storage circuit 12, and the input/output device 13. The processor 14 may be responsible for all or part of the operation of the display apparatus 10. For instance, the processor 14 may be a central processing unit (CPU), a graphics processing unit (GPU), a programmable microprocessor for general or special use, a digital signal processor (DSP), a programmable controller, an application specific integrated circuit (ASIC), a programmable logic device (PLD), other similar devices, or a combination of the foregoing devices.

In an embodiment, the processor 14 may present at least one virtual screen and a tool bar image in a display interface of the rollable display 11. One virtual screen may cover a portion of a display region of the display interface of the rollable display 11. For instance, a resolution of each virtual screen may be expressed as N pixels×M pixels. It should be noted that if a plurality of virtual screens are simultaneously presented in the display interface of the rollable display 11, these virtual screens do not overlap each other. In addition, the processor 14 may control the image displayed on each virtual screen.

In an embodiment, each virtual screen may be configured to present a target image. For instance, the target image may include one of a desktop image and an application image. The desktop image may include a predetermined desktop image provided by the operating system running on the processor 14 or a user-customized desktop image. The application image may include an execution screen of at least one application currently running in the foreground.

In an embodiment, the processor 14 may present at least one virtual button in the tool bar image. Each virtual button is configured to launch an application. In an embodiment, the processor 14 may further present more useful information (such as power information or network connection information and the like of the display apparatus 10) in the tool bar image, which is not limited by the disclosure.

In an embodiment, the processor 14 may detect a physical status of the rollable display 11. In response to a change in the physical status of the rollable display 11, the processor 14 may adjust presenting positions of the tool bar image and the at least one virtual screen in the display interface of the rollable display 11.

In an embodiment, a change in the physical status of the rollable display 11 may include the physical status of the rollable display 11 changing from a specific physical status (also referred to as a first physical status) to another physical status (also referred to as a second physical status). In an embodiment, in response to the physical status of the rollable display 11 changing from the first physical status to the second physical status, the processor 14 may adjust the presenting position of the tool bar image in the display interface of the rollable display 11 from a specific position (also referred to as a first position) to another position (also referred to as a second position). The first position is different from the second position.

In an embodiment, a change in the physical status of the rollable display 11 may include a change in a size of the display interface of the rollable display 11. For instance, in the first physical status, the display interface of the rollable display 11 has a specific size (also referred to as a first size). Further, in the second physical status, the display interface of the rollable display 11 has another size (also referred to as a second size). The first size is different from the second size.

In an embodiment, the size of the display interface of the rollable display 11 may be configured to describe a length or a width of the display interface of the rollable display 11. For instance, in an embodiment, in the first physical status, the length of the display interface of the rollable display 11 may be the first size, and in the second physical status, the length of the display interface of the rollable display 11 may be the second size. Alternatively, in an embodiment, in the first physical status, the width of the display interface of the rollable display 11 may be the first size, and in the second physical status, the width of the display interface of the rollable display 11 may be the second size.

In an embodiment, a distance between the first position and the second position may be positively related to a difference value between the first size and the second size. Accordingly, in an embodiment, after the physical status of the rollable display 11 changes, if the difference value between the first size and the second size increases, the distance the tool bar image is moved in the display interface of the rollable display 11 may also increase.

In an embodiment, it is assumed that the tool bar image is presented on a specific virtual screen (also referred to as a first virtual screen). In response to the physical status of the rollable display 11 changing, for example, from the first physical status to the second physical status, the processor 14 may adjust the presenting position of the first virtual screen in the display interface of the rollable display 11 from a specific position (also referred to as a third position) to another position (also referred to as a fourth position). The third position is different from the fourth position. Further, the processor 14 may adjust the presenting position of the tool bar image in the display interface from the first position to the second position without changing a relative position between the first virtual screen and the tool bar image.

In other words, in an embodiment, it is assumed that the tool bar image is presented on the first virtual screen. In response to the physical status of the rollable display 11 changing, for example, from the first physical status to the second physical status, the processor 14 may simultaneously move the tool bar image and the first virtual screen in the display interface of the rollable display 11. In particular, during the process of moving the tool bar image and the first virtual screen, the relative position between the first virtual screen and the tool bar image is not changed.

In an embodiment, in response to the physical status of the rollable display 11 changing, the processor 14 may adjust the total number of virtual screens presented in the display interface of the rollable display 11. For instance, at a specific point in time, the total number of virtual screens presented in the display interface of the rollable display 11 may be positively related to the size of the display interface of the rollable display 11 at that point in time. That is, if the size of the display interface of the rollable display 11 increases at a specific point in time, the number of virtual screens presented in the display interface of the rollable display 11 may grow at that point in time.

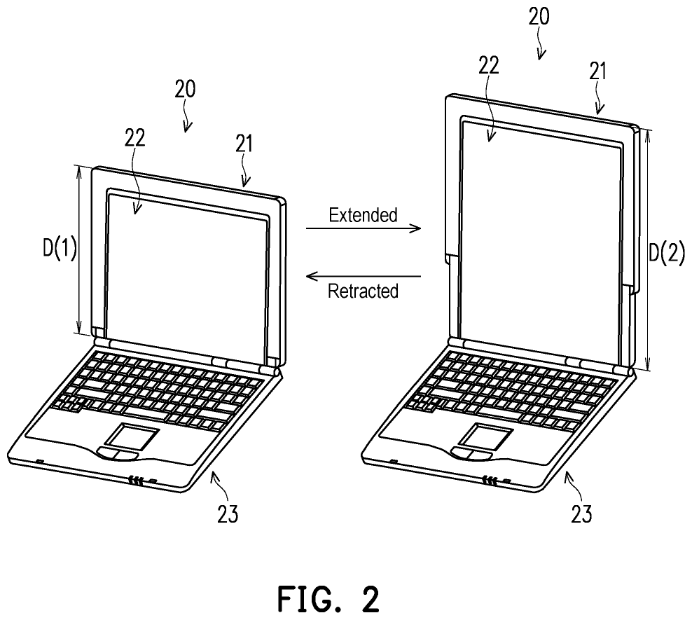

FIG. 2 is a schematic view illustrating a change in a physical status of a rollable display according to an embodiment of the disclosure. With reference to FIG. 2, it is assumed that the display apparatus 10 includes a display apparatus 20, and the rollable display 11 includes a rollable display 21. The rollable display 21 may present an image through a display interface 22. In an embodiment, the display apparatus 20 may further include a physical keyboard 23. For example, the physical keyboard 23 may belong to the input/output device 13 of FIG. 1. Alternatively, in an embodiment, the display apparatus 20 may not include the physical keyboard 23.

In an embodiment, the processor 14 may detect whether a size of the display interface 22 of the rollable display 11 changes. In response to the size of the display interface 22 changing, such as being extended or retracted, the processor 14 may determine that the physical status of the rollable display 11 changes.

In an embodiment, in response to the display interface 22 being extended, the size (e.g., length) of the display interface 22 may be changed from D(1) to D(2), and D(2) is greater than D(1). That is, by extending the display interface 22, a display area of the display interface 22 may be gradually enlarged. In contrast, in response to the display interface 22 being retracted, the size (e.g., length) of the display interface 22 may be changed from D(2) to D(1). That is, by retracting the display interface 22, the display area of the display interface 22 may be gradually reduced.

It should be noted that the embodiment of FIG. 2 is an example in which the display interface 22 of the rollable display 11 is extended or retracted in a length direction of the display interface 22 as the physical status of the rollable display 11 changes. However, in another embodiment, a change in the physical status of the rollable display 11 may also include, for example, the display interface 22 of the rollable display 11 being extended or retracted in a width direction of the display interface 22, which is not limited by the disclosure.

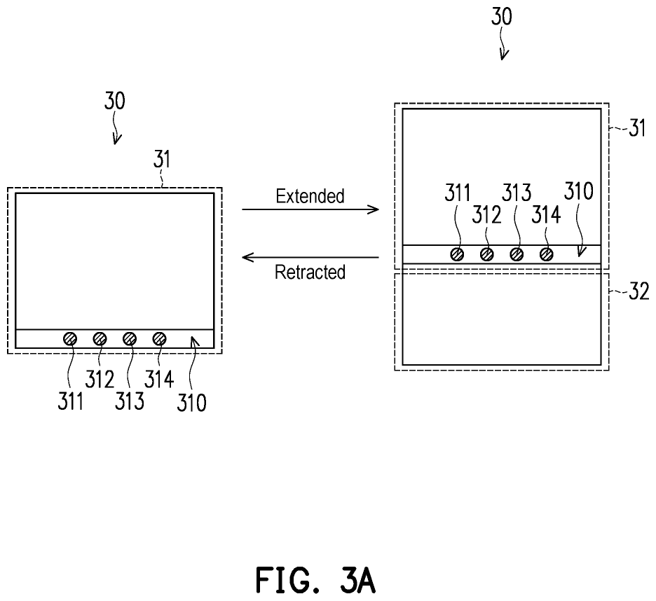

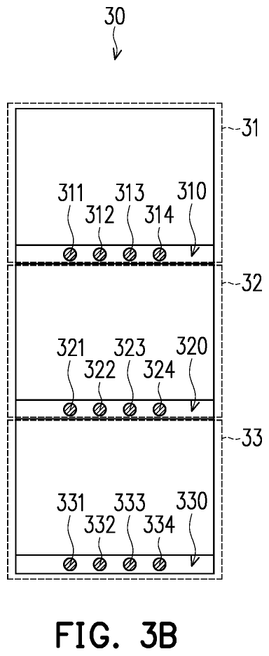

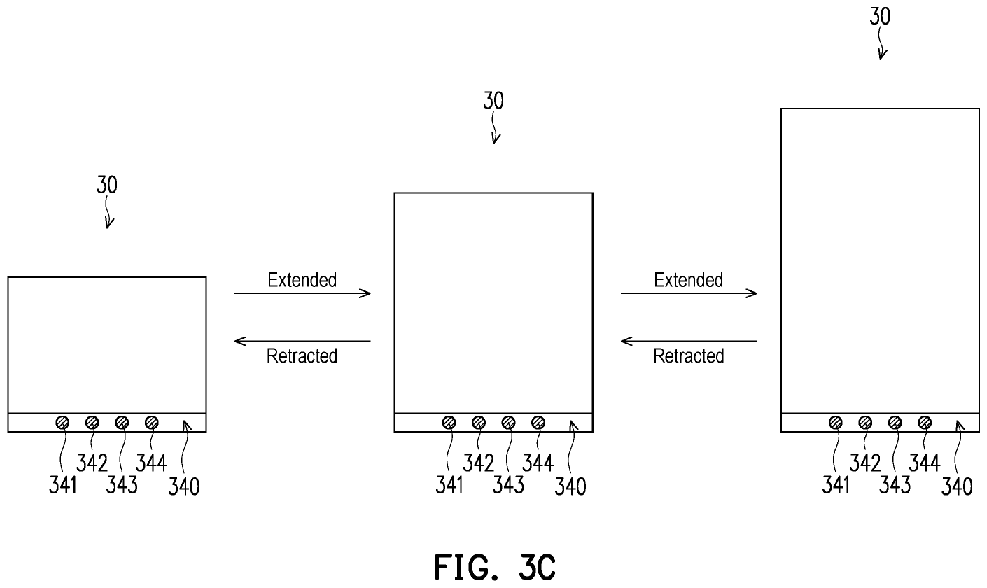

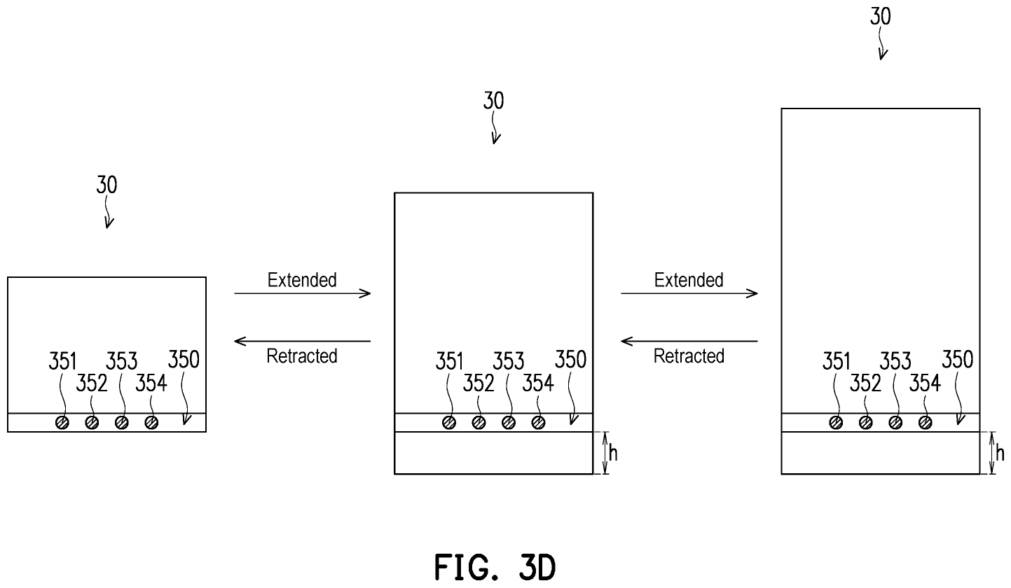

FIG. 3A is schematic view illustrating adjustment of presenting positions of a tool bar image and a virtual screen in a display interface of the rollable display according to an embodiment of the disclosure. With reference to FIG. 3A, in an embodiment, it is assumed that the display interface of the rollable display 11 includes a display interface 30.

In an embodiment, in a predetermined status, a virtual screen 31 (i.e., the first virtual screen) and a tool bar image 310 may be presented in the display interface 30. The tool bar image 310 may be presented on the virtual screen 31. For instance, the tool bar image 310 may be presented at a bottom portion of the virtual screen 31. For instance, virtual buttons 311 to 314 may be presented in the tool bar image 310. The virtual buttons 311 to 314 are configured to launch corresponding applications. It should be noted that the presenting position of the tool bar image 310 on the virtual screen 30 and the total number, type, and order of virtual buttons presented in the tool bar image 310 may be adjusted according to practical needs and are not limited by the disclosure.

In an embodiment, in response to a change in the physical status of the rollable display 11, such as the display interface 30 being extended, the processor 14 may move the virtual screen 31 and the tool bar image 310 simultaneously. For instance, as the display interface 30 is extended, the processor 14 may simultaneously move the virtual screen 31 and the tool bar image 310 upward in the display interface 30. For instance, during the process of moving the virtual screen 31 and the tool bar image 310, the presenting position of the tool bar image 310 in the display interface 30 may be changed from an original position (i.e., the first position) to a new position (i.e., the second position). At the same time, the presenting position of the virtual screen 31 in the display interface 30 may be changed from the original position (i.e., the third position) to a new position (i.e., the fourth position), as shown in FIG. 3A. In particular, during the process of moving the virtual screen 31 and the tool bar image 310, the relative position between the virtual screen 31 and the tool bar image 310 may remain unchanged.

In an embodiment, in response to a change in the physical status of the rollable display 11, such as the display interface 30 being extended, the processor 14 may also present at least a portion of a virtual screen 32 in the display interface 30. It should be noted that the virtual screens 31 and 32 do not overlap each other. For instance, after the virtual screen 31 and the tool bar image 310 are moved up simultaneously, at least a portion of the virtual screen 32 may be presented below the virtual screen 31. As the extent to which the display interface 30 is extended increases (i.e., the size of the display interface increases), more portions of the virtual screen 32 may be presented in the display interface 30. In addition, the virtual screen 32 may not be presented in the display interface 30 before the display interface 30 is extended.

FIG. 3B is schematic view illustrating presentation of a plurality of tool bar images and a plurality of virtual screens in the display interface of the rollable display according to an embodiment of the disclosure. With reference to FIG. 3 and the embodiment of FIG. 3A again, in an embodiment, after the display interface 30 is further extended, the processor 14 may simultaneously present virtual screens 31 to 33 and tool bar images 310 to 330 in the display interface 30. For instance, the tool bar images 310 to 330 may be located at the bottom portions of the virtual screens 31 to 33. Virtual buttons 311 to 314 may be presented in the tool bar image 310. Virtual buttons 321 to 324 may be presented in the tool bar image 320. Virtual buttons 331 to 334 may be presented in the tool bar image 330. It should be noted that the presenting position of each tool bar image on the virtual screen and the total number, type, and order of virtual buttons presented in each tool bar image may be adjusted according to practical needs and are not limited by the disclosure.

In an embodiment, after the display interface 30 is extended, the total number of tool bar images presented in the display interface 30 may be less than or equal to the total number of virtual screens presented in the display interface 30. For instance, in another embodiment of FIG. 3B, after the display interface 30 is extended, only at least one or at least two of the tool bar images 310 to 330 may be displayed.

In an embodiment, in response to the physical status of the rollable display 11 changing again, such as the display interface 30 being retracted, the processor 14 may also gradually hide at least a portion of the virtual screens 33 (and 32). Taking FIG. 3A and FIG. 3B as an example, in the process of gradually retracting the previously extended display interface 30, at least a portion of the virtual screen 33 may be hidden first. As the display interface 30 continues to be retracted, at least a portion of the virtual screen 32 may continue to be hidden until returning to the predetermined status of the display interface 30.

FIG. 3C is schematic view illustrating adjustment of the presenting positions of the tool bar image and the virtual screen in the display interface of the rollable display according to an embodiment of the disclosure. With reference to FIG. 3C, in an embodiment, after the display interface 30 is extended, the processor 14 may continue to present a tool bar image 340 at a specific position in the display interface 30. For instance, this specific position may be the bottom portion of the display interface 30. Virtual buttons 341 to 344 may be presented in the tool bar image 340. In other words, in an embodiment, no matter how the physical status of the rollable display 11 (or the size of the display interface 30) changes, the tool bar image 340 may continue to be maintained at the bottom portion of the display interface 30.

FIG. 3D is schematic view illustrating adjustment of the presenting positions of the tool bar image and the virtual screen in the display interface of the rollable display according to an embodiment of the disclosure. With reference to FIG. 3D, in an embodiment, after the display interface 30 is extended, the processor 14 may continue to present a tool bar image 350 at a specific position in the display interface 30. For instance, a distance between this specific position and the bottom portion of the display interface 30 is h, and the value of h may be set according to practical needs and/or may be adjusted by a user. Virtual buttons 351 to 354 may be presented in the tool bar image 350. In other words, in an embodiment, no matter how the physical status of the rollable display 11 (or the size of the display interface 30) changes, the distance (i.e., h) between the presented toolbar image 350 and the bottom portion of the display interface 30 may be maintained unchanged.

It should be noted that in the embodiments of FIG. 3C and FIG. 3D, the processor 140 may also present one or more virtual screens in the display interface 30 according to the physical status of the rollable display 11 (or the size of the display interface 30). Further, changes in the total number and/or position of the virtual screens presented may not affect the presenting position of the tool bar image 340 and/or 350. For instance, in the embodiment of FIG. 3C, even if a plurality of virtual screens are presented in the extended display interface 30, the total number of tool bar image 340 may still be maintained at one, and the tool bar image 340 may be continuously displayed at the bottom portion of the display interface 302. Alternatively, in the embodiment of FIG. 3D, even if a plurality of virtual screens are presented in the extended display interface 30, the total number of tool bar image 350 may still be maintained at one, and distance between the tool bar image 350 and the bottom portion of the display interface 30 may be maintained as h.

In an embodiment, in response to the physical status of the rollable display 11 changing, the processor 14 may adjust the resolution of the virtual screen presented on the display interface of the rollable display 11. By adjusting the resolution of the virtual screen, an image presented through the virtual screen may exhibit a better picture presentation effect, so the user experience is improved.

Taking FIG. 3A as an example, in an embodiment, in response to the display interface 30 being extended, the processor 14 may expand a coverage of the virtual screen 31 in the display interface 30 by adjusting the resolution of the virtual screen 31. In this way, as the display interface 30 is gradually extended, the coverage of the virtual screen 31 in the display interface 30 may also be gradually increased, so that the user experience of operating or viewing the virtual screen 31 may also be improved. Besides, in response to the display interface 30 being retracted, the processor 14 may reduce the coverage of the virtual screen 31 in the display interface 30 by adjusting the resolution of the virtual screen 31.

In an embodiment, in response to the physical status of the rollable display 11 changing, the processor 14 may continue to present a specific object in the display interface of the rollable display 11. This can prevent the user from being unable to find the specific object after adjusting the size of the display interface.

Taking FIG. 3A as an example, in an embodiment, it is assumed that after the display interface 30 is extended, according to user operations, the processor 14 may set a specific object presented in the virtual screen 32 as an object that needs to be continuously displayed. For instance, the specific object may include a specific window and/or a specific operable object presented in the virtual screen 32. Thereafter, during or after retracting the display interface 30, regardless of whether the virtual screen 32 is still presented in the display interface 30, the processor 14 may control the rollable display 11 to continue to present this specific object (that is, the object that is set to be an object that needs to be continuously displayed) in the display interface 30 (that is, according to the reduced or hidden virtual screen 32, the corresponding object that needs to be continuously displayed is changed to be displayed on the virtual screen 31). This avoids the situation where the user cannot find this specific object after the display interface 30 is retracted.

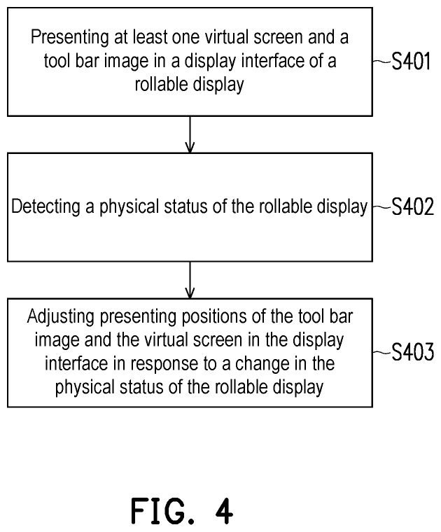

FIG. 4 is a flow chart of an image presenting method according to an embodiment of the disclosure. With reference to FIG. 4, in step S401, at least one virtual screen and a tool bar image are presented in a display interface of a rollable display. In step S402, a physical status of the rollable display is detected. In step S403, in response to a change in the physical status of the rollable display, presenting positions of the tool bar image and the virtual screen are adjusted in the display interface.

Each step of FIG. 4 has been described in detail in the foregoing paragraphs, and description thereof is thus not repeated herein. It should be noted that each step of FIG. 4 may be implemented as a plurality of program codes or circuits, which is not particularly limited by the disclosure. In addition, the method of FIG. 4 may be used in combination with the above-described exemplary embodiments or may be used solely, which is not particularly limited by the disclosure.

In view of the foregoing, compared to the conventional tool bar image that can only be displayed at a specific position (such as the bottom portion of the display interface) in the display interface of the monitor, in the image presenting method and the display apparatus provided by the embodiments of the disclosure, the presenting positions of the tool bar image and the virtual screen in the display interface of the rollable display may be dynamically adjusted according to the current physical status of the rollable display. Further, the total number of virtual screens presented in the display interface of the rollable display, the resolution of the virtual scree, and the presenting position of a specific object in the display interface may all be dynamically adjusted according to the current physical status of the rollable display. In this way, the user's operating experience for the rollable display may be effectively improved.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

1. An image presenting method for a display apparatus comprising a rollable display, the image presenting method comprising:
presenting at least one virtual screen and a tool bar image in a display interface of the rollable display;
detecting a physical status of the rollable display; and
adjusting presenting positions of the tool bar image and the at least one virtual screen in the display interface in response to a change in the physical status, wherein a total number of the tool bar image presented in the display interface is less than a total number of the at least one virtual screen presented in the display interface,
wherein the at least one virtual screen comprises a first virtual screen and a second virtual screen, the tool bar image comprises a first tool bar image, and the first tool bar image is presented between the first virtual screen and the second virtual screen.

2. The image presenting method according to claim 1, wherein the step of adjusting the presenting positions of the tool bar image and the at least one virtual screen in the display interface in response to a change in the physical status comprises:
adjusting the presenting position of the tool bar image in the display interface from a first position to a second position in response to the physical status of the rollable display changing from a first physical status to a second physical status, wherein the first position is different from the second position.

3. The image presenting method according to claim 2, wherein the display interface of the rollable display has a first size in the first physical status, the display interface of the rollable display has a second size in the second physical status, the first size is different from the second size, and a distance between the first position and the second position is positively related to a difference value between the first size and the second size.

4. The image presenting method according to claim 2, wherein the tool bar image is presented in a first virtual screen in the at least one virtual screen, and the step of adjusting the presenting position of the tool bar image in the display interface from the first position to the second position in response to the physical status of the rollable display changing from the first physical status to the second physical status comprises:
adjusting the presenting position of the first virtual screen in the display interface from a third position to a fourth position in response to the physical status of the rollable display changing from the first physical status to the second physical status, wherein the third position is different from the fourth position; and
adjusting the presenting position of the tool bar image in the display interface from the first position to the second position without changing a relative position between the first virtual screen and the tool bar image.

5. The image presenting method according to claim 1, further comprising:
presenting at least one virtual button in the tool bar image, wherein each of the at least one virtual button is configured to launch an application.

6. The image presenting method according to claim 1, further comprising:
adjusting the total number of the at least one virtual screen in response to a change in the physical status.

7. The image presenting method according to claim 1, further comprising:
adjusting a resolution of the at least one virtual screen in response to a change in the physical status.

8. The image presenting method according to claim 1, further comprising:
setting a specific object presented in the display interface as an object that needs to be continuously displayed according to a user operation; and
continuously presenting the specific object in the display interface after the physical status changes.

9. A display apparatus, comprising:
a rollable display; and
a processor coupled to the rollable display,
wherein the processor is configured to:
present at least one virtual screen and a tool bar image in a display interface of the rollable display;
detect a physical status of the rollable display, and
adjust presenting positions of the tool bar image and the at least one virtual screen in the display interface in response to a change in the physical status, wherein a total number of the tool bar image presented in the display interface is less than a total number of the at least one virtual screen presented in the display interface,
wherein the at least one virtual screen comprises a first virtual screen and a second virtual screen, the tool bar image comprises a first tool bar image, and the first tool bar image is presented between the first virtual screen and the second virtual screen.

10. The display apparatus according to claim 9, wherein the operation of the processor of adjusting the presenting positions of the tool bar image and the at least one virtual screen in the display interface in response to a change in the physical status comprises:
adjust the presenting position of the tool bar image in the display interface from a first position to a second position in response to the physical status of the rollable display changing from a first physical status to a second physical status, wherein the first position is different from the second position.

11. The display apparatus according to claim 10, wherein the display interface of the rollable display has a first size in the first physical status, the display interface of the rollable display has a second size in the second physical status, the first size is different from the second size, and a distance between the first position and the second position is positively related to a difference value between the first size and the second size.

12. The display apparatus according to claim 10, wherein the tool bar image is presented in a first virtual screen in the at least one virtual screen, and the operation of the processor of adjusting the presenting position of the tool bar image in the display interface from the first position to the second position in response to the physical status of the rollable display changing from the first physical status to the second physical status comprises:
adjust the presenting position of the first virtual screen in the display interface from a third position to a fourth position in response to the physical status of the rollable display changing from the first physical status to the second physical status, wherein the third position is different from the fourth position, and
adjust the presenting position of the tool bar image in the display interface from the first position to the second position without changing a relative position between the first virtual screen and the tool bar image.

13. The display apparatus according to claim 9, wherein the processor is further configured to:
present at least one virtual button in the tool bar image, wherein each of the at least one virtual button is configured to launch an application.

14. The display apparatus according to claim 9, wherein the processor is further configured to:
adjust the total number of the at least one virtual screen in response to a change in the physical status.

15. The display apparatus according to claim 9, wherein the processor is further configured to:
adjust a resolution of the at least one virtual screen in response to a change in the physical status.

16. The display apparatus according to claim 9, wherein the processor is further configured to:
set a specific object presented in the display interface as an object that needs to be continuously displayed according to a user operation, and
continuously present the specific object in the display interface after the physical status changes.
